(19) United States
(12) Patent Application Publication
(10) Pub. No.: US 2012/0305476 A1
(43) Pub. Date: Dec. 6, 2012

(54) TREATMENT METHOD FOR REDUCING THE PRODUCTION OF AN H2S COMPOUND IN AQUEOUS EFFLUENTS PASSING INTO A PIPE

(75) Inventors: Marie-Thérèse Giudici-Orticoni, Marseille (FR); Gisèle Leroy, Marseille (FR); Vincent Mejean, Marseille (FR); Patrick Lanneluc, Ceyreste (FR); Gérard Lieutaud, Marseille (FR)

(73) Assignees: CENTRE NATIONAL DE LA RECHERCHE SCIENTIFIQUE (CNRS), Paris Cedex 16 (FR); SOCIETE DES EAUX DE MARSEILLE, Marseille (FR)

(21) Appl. No.: 13/575,341

(22) PCT Filed: Jan. 12, 2011
(86) PCT No.: PCT/FR2011/050049

§ 371 Date: Aug. 9, 2012

(30) Foreign Application Priority Data
Feb. 3, 2010 (FR) 1050745

(51) Int. Cl. C02F 3/30; C02F 1/68; C02F 3/34

(52) U.S. Cl. 210/605; 210/170.01

(57) ABSTRACT

A treatment method for reducing or preventing the production of sulfide compounds of hydrogen such as H₂S dissolved in aqueous effluent constituents of waste water passing through a conduit of a sewerage system upstream of a plant for the biological treatment of water, the conduit containing sulfate-reducing bacteria and organic or mineral sulfur-containing compounds, wherein an alkaline-earth or alkali metal nitrite is injected into the effluent entering the conduit, the effluent and/or the bacterial biofilm covering the inner wall of the conduit containing or being supplemented, if necessary, by a combination of aerobic bacteria and anaerobic bacteria other than SRB bacteria, the concentration of nitrite injected into the effluent entering the conduit under full load being 0.036 mole/m³ to 0.087 mole/m³ to reduce the concentration of H₂S dissolved in the effluent at the outlet from said conduit that would be produced in the absence of nitrite by 1 g/m³.

The present invention relates to a method of treating effluents, more particularly for reducing or preventing the production of corrosive, malodorous, and toxic hydrogen sulfide, H₂S, by sulfate-reducing bacteria (SRB) in aqueous effluents passing intentionally or accidentally through a pipeline for transferring said aqueous effluents, more particularly a force main for waste water pumping plants.

Sewerage systems and urban and industrial treatment plants are rich in toxic substances that, during a burst or break of a pipeline, storage facility, or reactor cause water or ground contamination. In addition, urban waste water, in common with a lot of types of industrial waste water, generates malodorous compounds that constitute another form of pollution. This is a nuisance to residents and generates negative publicity for the works in question and for their operators.

Among the contaminants that are common to all of those environments are mercaptans and H₂S, present in industrial waste (refineries, petrochemicals plants, gas plants, paper plants, tanneries) but also in sewerage systems where they result from the anaerobic degradation of organic material by anaerobic bacteria. The H₂S produced also corrodes the equipment and chemical attack of the materials causes gradual degradation of the collectors and pollution of the surrounding sites. In addition, under certain conditions the dissolved sulfides may favor the development of filamentous bacteria, responsible for a reduction in treatment yields in plants for the biological treatment of effluents. Finally, H₂S is particularly toxic to man. It is an asphyxiating gas with potentially catastrophic effects, justifying regulation as regards exposure limits.

In summary, the following problems can be highlighted:
in the system:
generation of odors that may optionally be perceptible to a greater or lesser extent, but that are always nauseating;
premature degradation of systems by chemical attack and mechanical weakening (or in the extreme, even disappearance of a pipe);
particularly substantial toxicity of the gas that is generated (H₂S), with a major risk of an impact on the health of personnel working in a compromised atmosphere;
in the waste water treatment plant:
alteration of the biological treatment process, with a high risk of the development of filamentous bacteria that in particular prevent sludge from settling;
additional consumption of electricity in the treatment system to maintain aerobic conditions in the biological reactor (oxidizing medium);
treated water may develop a grayish color when treated with iron salts (generation of very fine iron sulfide that is difficult to settle).

The hydrogen sulfide, H₂S, present in waste water is not the result of a chemical reaction in the strict sense of the term, but derives from a bacterial degradation process (by reduction) of sulfur-containing compounds present in the effluent. It is the result of the presence and development of sulfate-reducing bacteria (SRB), which themselves respond to a certain number of criteria that have now been well defined, and of mineral sulfur-containing compounds such as sulfates, or of compounds of organic origin such as sulfonate compounds.

Thus, the reaction scheme for the production of sulfides from sulfate is as follows:

SRB bacteria+SO₄²⁻H₂O→H₂S

The behavior of sulfides in solution obeys an equilibrium relationship with the H₂S gas generated by the SRB and dissolved in water, which is in equilibrium in the water with other sulfide species HS and S²⁻ that is dependent on pH, temperature, and pressure. Hydrogen sulfide is a weak acid, and so in aqueous solution it obeys the following two chemical equilibrium systems with the species HS⁻ and S²⁻:

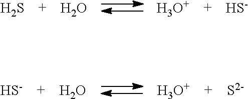

Sulfate-reducing bacteria (SRB) are strict anaerobic bacteria that are found not only in effluents, but that also stick to the wall in a bacterial biofilm covering the inner walls of the effluent transfer pipelines.

The intensity of the biological process for the production of H₂S is primarily influenced by the following parameters:
the temperature of the effluent: increasing this parameter favors the development and activity of SRB microorganisms;
the residence time of the effluent in the pipelines favors anaerobic conditions; and
the slow speed of movement in the effluents in the pipelines favors the accumulation of deposits, septic conditions and maintenance of the biofilm.

The calculation of the production of sulfides in a sewerage system is a function of the residence time for the effluent in the pipeline (i.e. parameters such as: the volume of the conduit/flow rate of the supply pump, the speed of flow of the effluent, the redox potential of the effluent, inter alia), and is a parameter that can be determined experimentally by the skilled person, along with the concentration of hydrogen sulfide in the air and in the water at various pHs. In this regard, the mechanical energy supplied by a fall into a holding tank before the effluents flow under gravity into the collection system has a major impact on the process for degassing hydrogen sulfide into air.

Controlling the concentration of dissolved sulfide in the effluents such that said concentration remains below 1.5 mg/L [milligrams per liter], preferably below 1 mg/L or less, is considered to be desirable.

Thus, the aim of the present invention is to provide a treatment method that counters the production of hydrogen sulfide dissolved in the effluents from sewerage systems.

Various techniques have been employed for this purpose that use chemical reagents such as ferric chloride, hydrogen peroxide, calcium nitrate or ferric nitrate. Those compounds have in common the fact that they react chemically with sulfides and/or inhibit the bacterial production of sulfides by an oxidizing stress. However, such treatments, which require large concentrations of chemical treatment reagents, are expensive and have a negative ecological impact as well as running the risk of a bactericidal effect that affects the performance of the downstream biological waste water treatment plants; depending on the reagents in question, they also emit CO₂ and/or nitrogen into the air.

U.S. Pat. No. 5,750,392 describes a method of treating an aqueous system employed in oil field operating equipment in order to reduce the production of H₂S produced and present in said aqueous systems and in the crude oil produced, since the presence of hydrogen sulfide in said fluids both causes corrosion of the equipment used to transfer said fluids and also affects the commercial value of the crude oil produced.

U.S. Pat. No. 5,750,392 proposes adding relatively large quantities of a mixture of nitrite and nitrate and/or molybdate in total concentrations of 25 ppm [parts per million] to 500 ppm, i.e. 25 g/m³ [grams per cubic meter] to 500 g/m³, which has the effect of inhibiting the growth of SRB bacteria that produce H₂S, and favoring the growth of denitrifying bacteria such as the bacterium Thiobacillus denitrificans present in fluids originating from oil fields. No effect on hydrogen sulfide production is observed by treatment with nitrite alone.

A treatment method such as that described in U.S. Pat. No. 5,750,392 would not be appropriate for reducing hydrogen sulfide in waste water from sewerage systems for the following reasons:

1—the treatment causes the bacterial composition to be modified substantially; this could perturb the activity of the bacterial consortium that is in necessary symbiosis so that it can carry out the treatment of waste water in treatment plants located downstream from the sewerage system;

2—the treatment favors the proliferation of denitrifying bacteria and thus the production of N₂ gas, which favors the phenomenon of flotation in the waste water; this should be avoided;

3—the quantities of reagents necessary would result in costs that are too high, having regard to the current best performing treatment involving the use of ferric chloride FeCl₂, and also in major toxicity because molybdenum is used.

More particularly, the aim of the present invention is to provide a novel treatment method for combating the production of hydrogen sulfide, H₂S, in sewerage systems, which method is compatible with environmental constraints and in particular does not affect the biodiversity and thus the performance of plants for biologically treating waste water, and is economically compatible with economic constraints placed on the operation of sewerage systems.

More particularly, one aim of the present invention is to provide a treatment method that does not perturb the composition and the activity of the bacterial consortium in symbiosis treating waste water in biological treatment plants downstream from the conduits from the treated sewerage systems.

Sodium nitrite is a substance that is known to have an inhibiting effect on an enzyme involved in the production of H₂S, namely sulfite reductase produced by sulfate-reducing bacteria (SRB). However, it is also known, and has been observed in the present invention, that sodium nitrite also has a lethal effect on bacteria (pure strain). More generally, sodium nitrite is known to be highly toxic for aquatic organisms and more particularly for microorganisms.

For these various reasons, the manufacturers of sodium nitrite explicitly mention on their safety sheets that its entry into drains or watercourses must be avoided.

Moreover, sodium nitrite generates the phenomenon of N₂ gas being produced by certain bacteria known as “denitrifying” bacteria, and said nitrogen gas can cause a flotation phenomenon resulting from particles of fat rising and accumulating on the surface of the effluent, which requires additional cleaning in the downstream lifting stations.

In accordance with the present invention, it has been discovered that the presence of a symbiotic bacterial consortium with SRB bacteria in sewerage systems can be used to inhibit the activity of the key enzyme in the production of H₂S, sulfite reductase, by adding low concentrations of nitrite, and this is accomplished without destroying SRB bacteria and other bacteria of said bacterial consortium and without favoring the proliferation of denitrifying bacteria and developing the phenomenon of nitrogen gas production and of flotation in the effluents that could result therefrom.

More particularly, in the present invention it has been discovered that the bactericidal effect of sodium nitrite at concentrations at which the sodium nitrite inhibits the production of H₂S by SRB bacteria is dispensed with by using a combination of said SRB bacterium (bacteria) and aerobic bacteria and anaerobic bacteria other than SRB.

It has also been discovered that in the present invention, it is possible to control the concentration of sodium nitrite inhibiting the production of H₂S so as to obtain a concentration of dissolved sulfides in the effluents of less than 1.5 mg/L, or even less than 1 mg/L or less, without excess sodium nitrite leaching out, the sodium nitrite most probably being entirely consumed by the bacteria, which means that the effects induced by the toxicity of the sodium nitrite and the phenomenon of nitrogen gas production and flotation in effluents can be avoided.

This advantageous effect was discovered by tests on a combination of bacteria comprising sulfate-reducing bacteria from the genus Desulfovibrio and decontaminating anaerobic Gram negative (Gram−) bacteria that are compatible with a toxic environment such as Shewanella oneidensis, Rhodobacter sphaeroides, R. denitrificans, R. velkampi, Pseudomonas stutzeri, P. zobell and Rhospeudomonas palustri, as well as Gram positive (Gram+) bacteria such as bacteria from the genus Bacillus, such as Bacillus mojavensis or Bacillus amiloliquefaciens. This effect was then confirmed by the presence of a combination of bacteria comprising a wide range of pathogenic bacteria that are found naturally in waste water from sewerage systems, such as aerobic bacteria from the genuses Shigella, Salmonella and Escherichia, in particular Escherichia Coli and hydrolytic anaerobic bacteria from the genus Clostridium, in combination with SRB bacteria.

Bacteria from the genus Clostridium and Bacillus are known to be hydrolytic, fermentative bacteria, i.e. they degrade carbonaceous organic material into smaller sized residues.

More precisely, the present invention provides a treatment method of reducing or preventing the production of sulfide compounds of hydrogen such as H₂S dissolved in aqueous effluent constituents of waste water passing through a conduit of a sewerage system or any conduit upstream of a plant for the biological treatment of water, said conduit containing sulfate-reducing bacteria (SRB) and organic or mineral sulfur-containing compounds, the method being characterized in that an alkaline-earth or alkali metal nitrite, preferably sodium nitrite, is injected into said effluent entering said conduit, said effluent and/or the bacterial biofilm covering the inner wall of said conduit containing or being supplemented, if necessary, by a combination of aerobic bacteria and anaerobic bacteria other than SRB bacteria, preferably at least hydrolytic anaerobic bacteria that can degrade organic matter, the concentration of nitrite injected into the effluent entering a said conduit under full load being 0.036 mole/m³ [mole per cubic meter] to 0.087 mole/m³, preferably 0.058 mole/m³ to 0.087 mole/m³, to reduce the concentration of said compound H₂S dissolved in the effluent at the outlet from said conduit that would be produced in the absence of nitrite by 1 g/m³.

More particularly, waste water moving in the transfer pipeline of sewerage systems is treated, whereby the waste water and the biofilms covering said pipelines include a said bacterial combination comprising said aerobic bacteria selected from bacteria from the genuses Shigella, Salmonella, Escherichia, preferably E. coli, and said hydrolytic bacteria of the genus Clostridium and at least one said SRB bacterium selected from the genuses Desulfovibrio and Desulfomonas.

This combination of bacteria constitutes a consortium of bacteria, i.e. an assembly of bacteria developing in the same environment and involved in the same process for the degradation of organic matter in waste present in the effluents leading to the production of H₂S. In fact, the aerobic bacteria absorb oxygen and thus can be used in the development of hydrolytic anaerobic bacteria, which hydrolytic bacteria degrade the complex carbonaceous organic matter into smaller sized residues (lactate, acetate, etc.), these smaller sized residues providing carbon nutrients encouraging the development of SRB bacteria, which bacteria are then capable of degrading sulfur-containing organic compounds, such as compounds comprising sulfate or sulfonate groups, more easily.

However, in the present invention it has surprisingly been discovered that this bacterial consortium in symbiosis can inhibit the production of H₂S by SRB bacteria in the presence of alkali or alkaline-earth metal nitrite without having an impact on the environment in general downstream from said works, in particular of the conduit, since the nitrite has disappeared therefrom and the equilibrium of the bacterial ecosystem is not altered; in particular, the nitrite has not had a bactericidal effect either on said SRB bacteria present in the majority in the biofilm or on said aerobic bacteria and anaerobic bacteria in solution.

Thus, the presence of alkali or alkaline-earth metal nitrite means that the production of H₂S can be inhibited without degrading the bacterial ecosystem initially present in the biofilm of the conduit and in the moving aqueous effluent. This is a factor that favors maintenance of proper operation of the biological treatment plants generally located downstream from the sewerage systems, in particular those producing energy.

The waste water and transfer pipelines of the sewerage systems in which they move that, in the absence of treatment, produce malodorous concentrations of dissolved H₂S, namely of over 1 g/m³, in general more than 5 g/m³, endogenously contain the required quantities of SRB bacteria and aerobic bacteria and anaerobic bacteria other than SRB in consortium, as well as said sulfur-containing compound. The SRB bacteria are contained in the biofilm on the inner surface of the wall of said pipelines.

In the treatment method of the invention, sodium nitrite is injected into the effluent entering into a said conduit under full load in a concentration of 2.5 g/m³ to 6 g/m³, preferably 4 g/m³ to 6 g/m³ of sodium nitrite in the effluent entering the conduit to reduce the concentration of said compound H₂S dissolved in the effluent at the outlet from said conduit that would be produced in the absence of nitrite by 1 g/m³.

The term “conduit under full load” as used here means that said conduit is a conduit that is completely filled with waste water, i.e. under anaerobic conditions, as applies to force mains in lifting stations.

In other words, the effluent entering the conduit is injected at a concentration of 0.043 mole/m³ to 0.087 mole/m³ (3 g/m³ to 6 g/m³), preferably 0.058 mole/m³ to 0.073 mole/m³ (4 g/m³ to 5 g/m³) of nitrite (sodium nitrite) to reduce the production of the sulfide H₂S dissolved in the effluent by an amount of 1 g/m³. Thus, for a conduit with a dissolved sulfide content, calculated as a function of its mode of operation that is, in the absence of treatment, n g/m³ at the conduit outlet during operation periods, then 3×n g/m³ to 6×n g/m³ of nitrite is injected into the effluent entering the conduit. This range of concentrations is valid irrespective of the dimensions and mode of operation of the conduit.

The lower limit of 0.043 mole/m³ of nitrite (3 g/m³ of sodium nitrite) is defined as a function of obtaining an inhibiting effect on the production of the sulfide H₂S, while the upper limit of 0.087 mole/m³ of nitrite (6 g/m³ of sodium nitrite) is defined as a function of the prevention of the appearance of excess nitrite in the effluent at the conduit outlet.

An operator of a sewerage system can thus calculate the quantity of nitrite to be injected into the effluents as a function of the concentration of the sulfide H₂S measured in the absence of treatment during the operation period of the system in order to achieve a reduction that means that the concentration of H₂S in the water can be reduced to no more than 1.5 g/m³, preferably to no more than 1 g/m³ of dissolved sulfide in the water exiting the pipeline.

More particularly, waste water is treated in a said conduit under full load consisting in a rising force main supplied with waste water via a lifting pump from a cesspool at a lower level than said force main of a sewerage system.

Both in the waste water and in the biofilm covering the pipelines, these sewerage systems contain pathogenic bacteria such as aerobic Gram− bacteria of the genus Shigella, Escherichia coli, and Salmonella and anaerobic Gram+ bacteria of the genus Clostridium, in combination with sulfate-reducing bacteria especially from the genus Desulfovibrio. The most represented groups of bacteria are aerobic bacteria of the coliform type, approximately 30% of the bacteria, then SRB bacteria of the genus Desulfovibrio, in an amount of approximately 15%, and the hydrolytic and acidogenic group of anaerobic bacteria of the Clostridies type in an amount of approximately 10% and probably also other anaerobic bacteria, acetogenic bacteria and even methanogenic bacteria.

The majority of SRB bacteria are found in the biofilm and in contact with the wall of the pipelines, and it is assumed that the nitrite diffuses through the bacterial biofilm as the effluent advances along the conduit.

In accordance with other advantageous characteristics:
said nitrite is injected until the concentration of dissolved sulfide, H₂S, at the outlet from the conduit is reduced to a concentration of less than 1.5 g/m³, preferably 1 g/m³ or less.

Thus, for a conduit in which the operating conditions are such that the quantity of sulfide H₂S produced is (n g/m³=m×1.5 g/m³), then [3×(m⁻¹)×1.5 g/m³] to [6×(m−1)×1.5 g/m³] of sodium nitrite is injected such that only 1.5 g/m³ remains in the effluent at the outlet.
the concentration of said compound H₂S produced by said effluents moving in said conduit is reduced by a value of 5 g/m³ to 15 g/m³ relative to the value for the concentration of said compound H₂S in the effluents leaving the conduit in the absence of treatment.

In practice, in the pipelines installed in countries with temperate climates, the quantity of dissolved sulfide H₂S in the effluents from waste water from sewerage systems does not exceed 15 g/m³ to 20 g/m³.
said nitrite is injected with an injection dosing pump (7) the function of which is synchronized with that of said lifting pump (4).

In general, said lifting pumps function intermittently, i.e. they start up when and if the waste water in the cesspool exceeds a given limiting level. Thus, for a lifting pump that can supply the conduit in an amount (p) m³/h in the lifting period, the dosing pump injects: from (0.043×p) mole/h [moles per hour] to (0.084×p) mole/h of nitrite (i.e. (3×p) to (6×p) g/h of sodium nitrite).

The values for the concentration or the flow rate of said nitrite given above refer to concentrations of pure nitrite, even if it is used dissolved in solution.

In a preferred implementation, over a treatment period for the conduit of at least 48 h [hours], preferably not more than 72 h, the possibility of injecting nitrite into the effluents entering the conduit is interrupted for periods with a cumulative duration equal to at least half said treatment period of at least 48 h.

In accordance with another particularly advantageous treatment technique of the present invention, it has been discovered that an initial treatment with sodium nitrite under the concentration conditions mentioned above had an inhibiting effect on the production of sulfides by SRB bacteria that exhibits a certain remanence after interrupting the nitrite supply, such that the nitrite inhibiting effect is preserved if over a period of 48 h the cumulative period during which the lifting pump is likely to function, i.e. of injecting sodium nitrite, does not exceed half the period, i.e. 24 h.

In a first implementational variation, injection of said nitrite into effluents entering the conduit is carried out every other day, i.e. one day of continuous intermittent treatment is alternated with one day of a complete halt to any intermittent or continuous treatment.

In other words, treatment consisting of potentially injecting said nitrite into the effluent entering the conduit is interrupted every other day, during which stoppage period the lifting pump operates intermittently or continuously without injecting sodium nitrite into the effluent.

In a second implementational variation, said nitrite is injected into the effluent entering the conduit daily, but for only part of the day corresponding to the longest residence time for the effluents in the conduit, preferably at night, any possibility of treatment being interrupted for the other part of the day.

This mode of treatment by intermittent daily treatment with nitrite is sufficient to reduce the production of the sulfide H₂S dissolved in the effluent because of the remanence effect of the reagent on the productive activity of the SRB, which rests for a prolonged period after an initial treatment period at the treatment concentration concerned of 3 g to 6 g (0.043 mole to 0.084 mole) of sodium nitrite per gram of the dissolved sulfide H₂S to be reduced.

This intermittent treatment also means that having excess nitrite at the conduit outlet can be avoided; in particular, this intermittent treatment mode is particularly advantageous from an economics viewpoint to reduce the cost of treatment, since it means that the costs can be reduced by a factor of 2.

The present invention also provides a treatment facility for use in a method in accordance with the invention, comprising:
a cesspool;
a force main the upstream inlet of which opens into said cesspool and the downstream outlet of which opens at a greater height than that of said cesspool; and
a lifting pump that can supply said force main from said cesspool;

the facility being characterized in that it further comprises:
a storage tank for said nitrite; and
a dosing pump for injecting said nitrite into the inlet to said force main from said tank;
the operation of said dosing pump being capable of being synchronized with the operation of said lifting pump and being capable of operating continuously.

Advantageously, the facility of the invention comprises a holding tank including a manhole and cooperating with a gravity fed transfer conduit leading to a waste water treatment plant or to a second, downstream, lifting pump, the outlet from said force main opening into said holding tank, into which said effluents are discharged.

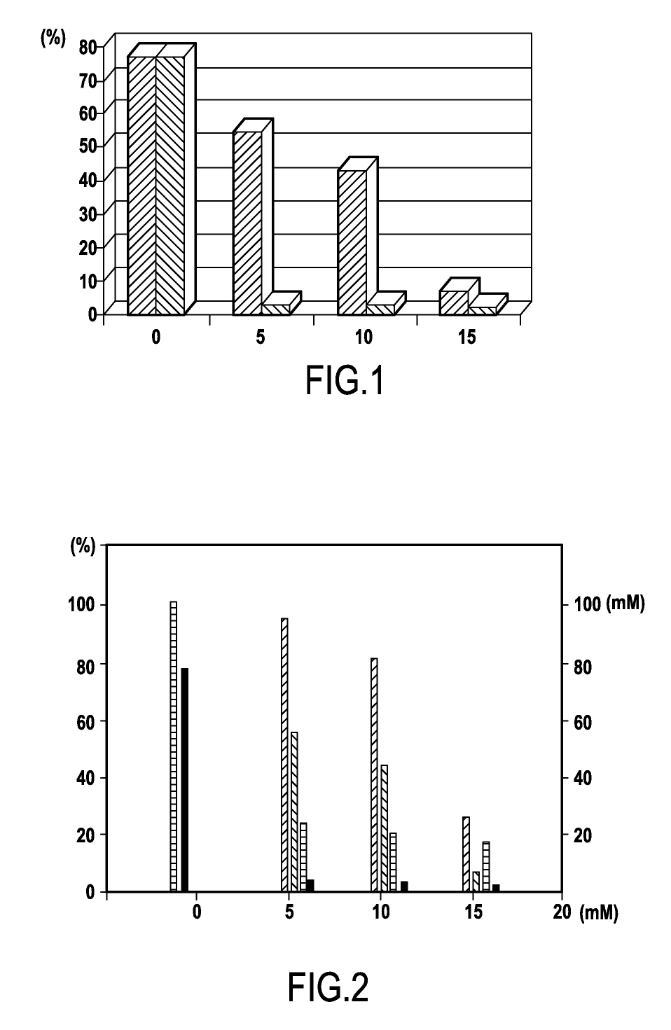

Other characteristics and advantages of the present invention become apparent from the following detailed description made with reference to FIGS. 1 to 6 in which:

FIG. 1 represents the course of H₂S production (%) for a culture with a stationary DvH bacterial phase in the presence of different concentrations of nitrite ( [symbol] ) or nitrate ( [symbol] ) in the culture medium (mM, along the abscissa), 100% production of H₂S being for the growth of DvH on a lactate/sulfate medium in the absence of treatment;

FIG. 2 represents the relationship between the quantity of biomass (%) and the production of H₂S (mM) for a stationary phase culture of DvH bacteria in the presence of different concentrations of nitrites or nitrates in the culture medium. The quantity of biomass (bacterial survival) is expressed as the % optical density (OD) at 600 nm [nanometer] compared with the OD at 600 nm of the biomass for a DvH culture on a lactate/sulfate medium in the absence of treatment, this culture representing 100%;

In FIG. 2, the quantities of biomass (% growth) and production of H₂S (mM) are shown under the following conditions: [symbol] =% growth+nitrite, [symbol] =H₂S production+nitrite, [symbol] =% growth+nitrate, [symbol] H₂S production+nitrate;

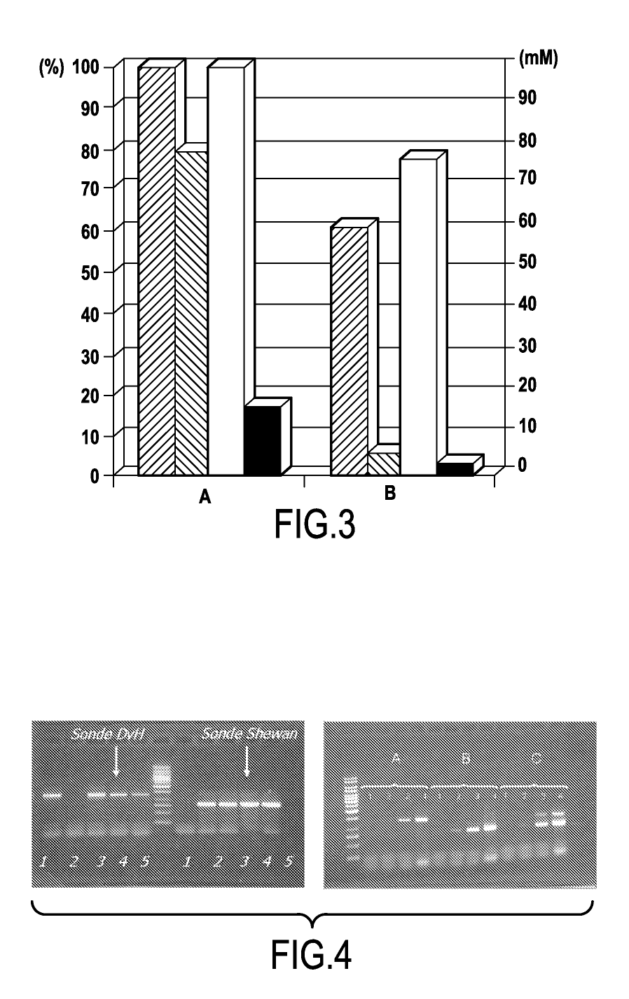

FIG. 3 represents the effect of adding exogenous bacteria of the Shewanella type on the growth of a strain of sulfate-reducing bacteria, DvH, in the presence of nitrate or nitrite (panel A, %=quantity of biomass expressed as a % of the optical density (OD) at 600 nm [nanometers], such that 100% represents the OD at 600 nm for the biomass of a culture of DvH on a lactate/sulfate medium in the absence of treatment) and on the production of H₂S (panel B, mM H₂S). The control (growth and production of H₂S) used a DvH culture with or without the addition of inhibitor. The effect of adding the Shewanella bacteria on the growth and production of H₂S is presented in the presence of nitrate (+nitrite) and in the absence of nitrite (nitrite). The Shewanella bacteria alone had no significant effect on H₂S production. In FIG. 3, the various symbols represent the experiments under the following conditions: [symbol] =5 mM of nitrate on a DvH+Shewanella consortium, [symbol] =consortium of DvH+Shewanella bacteria in the presence of 5 mM of nitrite, [symbol] =presence of DvH bacteria alone, [symbol] =presence of DvH bacteria alone+nitrite;

FIG. 4 represents monitoring bacteria species by PCR with specific probes on agarose gels revealed by EtBr after electrophoresis; the left hand panel represents the control for the specificity of the probes; the right hand panel represents the following: A=DvH culture alone; B=Shewanella culture; C=co-culture of DvH and Shewanella at increasing cell concentrations for columns 1 to 4;

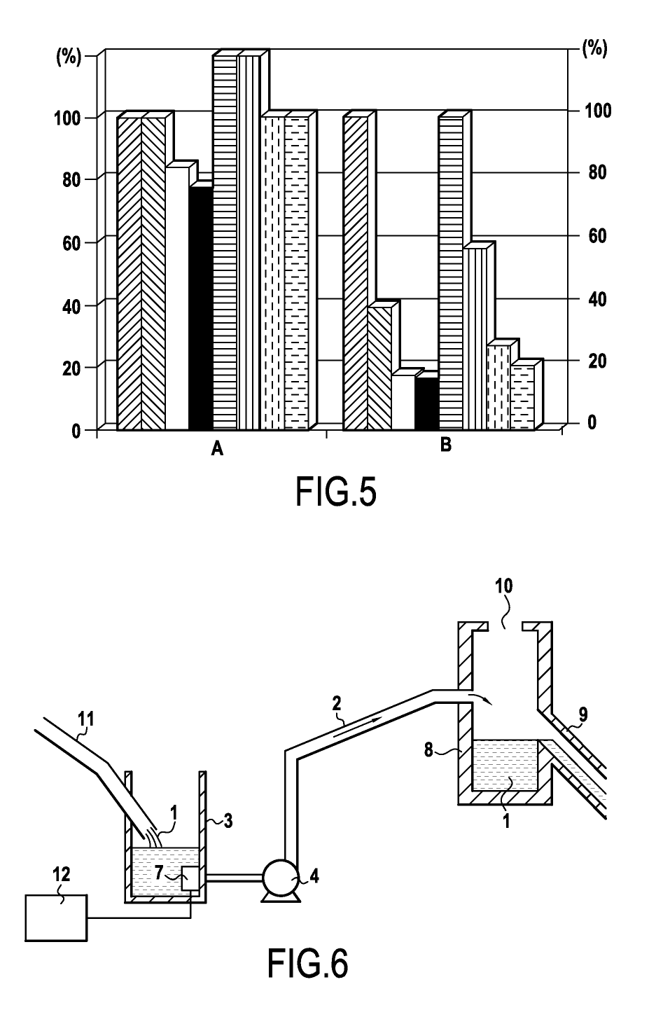

FIG. 5 represents monitoring of the production of H₂S (panel B: 100% represents the production of H₂S in the absence of treatment) and of biomass (panel A: 100% represents the OD of the biomass for growth on lactate/sulfate medium) on samples in the presence of different concentrations of nitrite or nitrate in which: [symbol] =sample alone, [symbol] =sample+3 mM of nitrite, [symbol] =sample+5 mM of nitrite, [symbol] =sample+10 mM of nitrite, [symbol] =sample+Shewanella, [symbol] =sample+Shewanella+3 mM of nitrite, [symbol] =sample+Shewanella+5 mM of nitrite, and [symbol] =sample+Shewanella+10 mM of nitrite;

FIG. 6 represents a diagram of a treatment facility of the invention.

The present invention consists in studying the feasibility of setting up monitoring of the ecosystems present in sewerage systems with the aim of preventing or limiting the environmental risks of H₂S pollution, by studying the metabolisms and processes of bacterial symbiosis. The term “H₂S” as used here means both “H₂S” and dissolved “HS⁻”.

Two modes of controlled inhibition of H₂S production were studied at the same time, namely:

1) controlling the biomass by adding symbiotic bacteria; and

2) adding metabolic inhibitors.

### 1) Laboratory Tests:

1.1) Firstly, experiments were carried out on laboratory bacterial models that were known and understood.

Experiments were carried out with the SRB bacterium Desulfovibrio vulgaris Hindelborough (DvH) for which the genome has been sequenced and which is the model system for the study of sulfate-reducing bacteria.

A wide range of non-pathogenic aerobic and anaerobic bacteria known to be decontaminants that are compatible with a toxic environment was tested, including the following Gram− aerobic bacteria: Shewanella oneidensis, Rhodobacter sphaeroides, Rhodobacter denitrificans, R. velkampi, Pseudomonas stutzeri, Pseudomonas zobell and Rhospeudomonas palustri, as well as the following anaerobic Gram+ bacteria: Bacillus mojavensis and Bacillus amiloliquefaciens.

The SRB bacteria developed at sulfate concentrations of at least 4 mM.

The culture medium was a lactate/sulfate medium comprising: sodium sulfate 28 mM, magnesium sulfate 8 mM, lactate 45 mM and oligoelements (iron, Zn, Mn, Cu, Co, Mo, Ni, Se, W, Mg).

These various strains were co-cultivated with DvH and tested in various ratios to monitor the production of H₂S. Of all of the synthetic systems that were set up, none of the synthetic consortia tested displayed any difference in the production of H₂S; adding exogenic bacteria, although it developed in the DvH culture, appeared to have no effect on the production of H₂S after 24 hours or 48 hours of growth.

Various metabolic inhibitors were tested at different concentrations; examples were the addition of iron, oxygen, or a detergent. With oxygen, the production of H₂S restarted as soon as the redox potential of the medium became negative again. With iron, this induced a drastic oxidizing stress and caused bacterial death. Finally, the detergents acted on the formation of biofilm and bacterial membranes. However, the various tests with detergents did not produce any tangible results. The study was continued by looking at the effect of adding small defined quantities of nitrite and nitrate on the production of H₂S by the SRB. Nitrite and nitrate are alternative electron acceptors that could potentially result in a reduction in the production of H₂S, but nitrite in particular is an inhibitor of a key enzyme in the production of H₂S, namely the sulfite reductase of SRB. However, this inhibition is reversible. Adding nitrite and nitrate to the culture medium resulted in a very significant reduction (approximately 90% of the production of H₂S), as can be seen in FIG. 1. It can be seen that the effect of nitrite was greater, since it is visible and substantial from 5 mM, while 15 mM of nitrate was necessary to obtain a similar inhibition under the same culture conditions.

In FIG. 2, bacterial survival was monitored. It can clearly be seen that there is a correlation between the reduction in the production of H₂S and the reduction in bacterial survival in the presence of nitrite with a higher negative effect for nitrite than for nitrate.

However, it has been discovered that it is possible to overcome this bactericidal effect problem by adding exogenic bacteria. Thus, using Shewanella bacteria in combination with the SRB bacterium, and adding nitrite induces a reduction in the production of H₂S while maintaining the biomass, as can be seen in FIG. 3, in contrast to what happens when adding nitrate—no significant reduction in H₂S production was observed in the presence of the same bacterial consortium.

PCR was used to check that the two bacterial species were still present after several days of co-culture in the presence of nitrite. To this end, a specific marker for each of the strains was selected: a probe taken from the gene for desulfoviridin coding for an enzyme for reducing sulfates for DvH (DvH probe) and a probe taken from the torF gene for the Shewanella bacterium (“Shewan probe”). These specific probes were synthesized and each gene was investigated by PCR in co-cultures; detection of the gene indicated the presence of the bacterium, as can be seen in the gels of FIG. 4.

After checking the isolated strains (A and B), the probes could indicate the presence of two bacterial strains in the co-culture C and at different growth times.

In conclusion, it has been shown that the nitrite has a very clear negative effect on the production of H₂S, i.e. a H₂S production reducing effect, but induces bacterial death, while the presence of an exogenous bacterium in consortium has a symbiotic effect, and has no amplifying effect on inhibition, but has a positive effect on cell survival since there is no more cell death, as shown in FIG. 5.

1.2) The same protocol was applied to waste water samples taken from a sewerage system. Two samples taken from that system revealed a high H₂S production in the stationary growth phase (lower portion of effluents) and the bacteria from the “sludge” sample (lower portion) primarily belonged to the following three major families of bacteria:
proteobacteria (Gram−) of the Shigella/Escherichia coli/Salmonella type;
Gram+ anaerobic bacteria of the Clostridium type; and
sulfate-reducing bacteria of the Desulfovibrio type in a quantity of approximately 30% by number therefor.

The sludge removed was tested for its H₂S production and the effect of nitrite and exogenous bacteria (Shewanella) and a nitrite+Shewanella combination were tested. The various tests carried out showed that:
nitrite induces a drop in the production of H₂S from 3 mM.

This inhibiting effect did not induce cell death even in the absence of Shewanella as long as the concentration of H₂S was 5 mM or less.

The exogenous Shewanella bacteria did not enhance the inhibiting effect.

These two results suggest that the bacteria present in the sample were sufficient to generate a stable symbiotic bacterial consortium preventing bacterial death.

Concentrations of nitrite of less than 5 mM allowed total consumption of nitrite by the bacteria.

Beyond 5 mM of nitrite, it was observed that the inhibiting effect on H₂S production reduced and the biomass was slightly affected (bactericidal effect).

It was demonstrated that nitrite was consumed over time but that the treatment carried out had a long-lasting effect or remanence effect on the bacteria, suggesting that this treatment method momentarily modifies the metabolic behavior of the bacteria consortium.

### 2) On-Site Tests

Experiments were carried out on a sewerage system diagrammatically shown in FIG. 6, comprising a cesspool 3 supplied with effluent 1 from a conduit 11, a lifting pump 4 that was used to supply a force main 2 from the cesspool 3 to a holding tank 8 cooperating with a gravity fed transfer conduit 9 to a treatment plant (not shown).

The rising force main 2, when full, is said to be under full load and the cesspool 8 constitutes a load break point.

The force main 2 was 1170 m [meter] long with a nominal diameter of 250 mm [millimeter], giving a volume of 57.5 m³. The delivery of the lifting pump was 150 m³/hour. A nitrite tank 12 cooperated with a dosing pump 7 to inject nitrite into the effluents entering the force main 2.

The concentration of sulfides at hourly intervals measured in the effluent leaving the force main varied as a function of the time of day. In periods from 06:30 a.m. to 08:30 a.m., the dissolved sulfides measured corresponded to water that had had the longest residence times in the force main, namely approximately 5.5 h, i.e. water that entered the conduit at night.

This water had the maximum quantity of sulfides, namely with a maximum production in the absence of treatment of 7.5 mg/L of sulfide, corresponding to a maximum flow rate of sulfide H₂S in the absence of treatment of 1125 g per hour of pumping.

The most frequent pumping periods (i.e. during the day) saw the sulfides concentration reducing to a value of 2 mg/L to 4 mg/L in the absence of treatment.

The mean intermittent pumping time for untreated water was 2.7 h/day, corresponding to a daily mean pumped volume of 435 m³ to 480 m³, with a pumping delivery of 150 m³/h.

Sodium nitrite NaNO₂ was tested in 40% by weight solution with a density of 1.3. This reagent was injected directly into the effluent pumping pit almost level with the inlet thereof into the force main via a dedicated dosing pump 7 that could reach a delivery of up to 14 L/h. Start-up of the dosing pump 7 was linked with that of the lifting pump 4 with the two pumps being stopped by a low level of effluents in the cesspool 3.

Various measurements for the concentration of sulfide in water leaving the force main were carried out. The concentration of sulfide in water was determined by means of an assay kit using the reaction of H₂S with aniline forming a colorless intermediate that is oxidized by ferric ions to a colored compound: methylene blue, an optical disk comparator with a color gradient, was used to determine the concentration of sulfide in the solution as a function of its color. The temperatures of the effluent and redox potential were measured at the holding tank or settling tank 8 using standard equipment.

Various tests were carried out over a period of 1 month; these showed that with concentrations of sodium nitrite of 2.5 g/m³ to 6 g/m³ injected in a synchronized manner, operating the lifting pumps every other day or only overnight between 2200 h and 0500 h, during which periods the residence time for the waste water was the longest in the pipelines, i.e. approximately 5.5 h, the maximum concentration of dissolved sulfides in the effluent at the outlet from the force main was reduced. Thus, with daily treatments with 2.5 g/m³ to 6 g/m³ of NaNO₂, it was possible to obtain a reduction of 1 g/m³ of dissolved sulfide produced by the conduit. Thus, the maximum quantity of dissolved sulfide H₂S at the outlet from the force main could be limited to 1.5 mg/L.

Using concentrations of sodium nitrite of 4 g to 5 g per gram of dissolved sulfide produced in the absence of treatment, the quantity of dissolved sulfites at the force main outlet could be limited to 1 mg/L.

For concentrations of sodium nitrite of more than 5-6 g of NaNO₂ per gram of dissolved sulfide H₂S produced in the absence of treatment, residual traces of sodium nitrite were observed in the effluents at the outlet from the conduit.

In particular, it was advantageously observed that the rise in the sulfide concentrations after stopping the nitrite treatment was only approximately 10%, and no more than 25% after 24 h, which was still acceptable.

These tests demonstrate that it is possible to carry out the treatment every other day, or daily but only at night, without increasing the quantity of dissolved sulfide by more than 10% compared with the level obtained at the end of the 24 h treatment period or once every two days or at the end of the daily nighttime treatment period.

Various measurements of the concentration of sulfide in water at the outlet from the force main were also carried out over the same period of one month, with ferric chloride instead of sodium nitrite.

The various studies carried out confirmed the following results:
the reagent had no curative effect, but a preventative effect, i.e. it prevented or reduced H₂S production;
the treatment reagent was consumed;
with excess nitrite, it was observed via the manhole that fats floated on the surface of the effluent in the holding tank when the pump was stopped;
the sodium nitrite had a remanence effect as regards its inhibiting activity, meaning that effluents could be treated in a transient manner and intermittently;
an advantageous ratio of nitrite (NO₂) was observed relative to ferric chloride (FeCl₃) of approximately 2.5 in terms of the FeCl₃/NO₂ quantity ratio in continuous daily treatment, but an even more advantageous ratio of approximately 4 with alternating treatment, i.e. every other day or simply every night.

Despite the higher cost of sodium nitrite, the treatment of the invention is economically more advantageous than the current better performing treatment with FeCl₃.

Thus, the presence of alkali or alkaline-earth metal nitrite can inhibit the production of H₂S without degradation of the bacterial ecosystem already present in the biofilm of the conduit and in the aqueous effluent moving therein. This in particular is a factor that is favorable to keeping the biological treatment plants that are generally located downstream from the sewerage systems, in particular those producing energy, operating properly.

1. A treatment method for reducing or preventing the production of sulfide compounds of hydrogen such as H₂S dissolved in aqueous effluent constituents of waste water (1) passing through a conduit (2) of a sewerage system or any conduit upstream of a plant for the biological treatment of water, said conduit containing sulfate-reducing bacteria (SRB) and organic or mineral sulfur-containing compounds, the method being characterized in that an alkaline-earth or alkali metal nitrite, preferably sodium nitrite, is injected into said effluent entering said conduit, said effluent and/or the bacterial biofilm covering the inner wall of said conduit containing or being supplemented, if necessary, by a combination of aerobic bacteria and anaerobic bacteria other than SRB bacteria, the concentration of nitrite injected into the effluent entering a said conduit under full load being 0.036 mole/m³ to 0.087 mole/m³, to reduce the concentration of said compound H₂S dissolved in the effluent at the outlet from said conduit that would be produced in the absence of nitrite by 1 g/m³.

2. A method according to claim 1, characterized in that the waste water (1) is treated in a said conduit under full load consisting in a rising force main (2) supplied with waste water via a lifting pump (4) from a cesspool (3) below said force main of a sewerage system.

3. A treatment method according to claim 1, characterized in that said, sodium nitrite is injected at a concentration of 2.5 g/m³ to 6 g/m³, until the concentration of the dissolved sulfide H₂S at the conduit outlet has a concentration of less than 1.5 g/m³.

4. A treatment method according to claim 1, characterized in that the concentration of said compound H₂S produced by said effluents moving in said conduit is reduced by a value of 5 g/m³ to 15 g/m³ relative to the value for the concentration of said compound H₂S in the effluents leaving the conduit in the absence of treatment.

5. A method according to claim 1, characterized in that said nitrite is injected with an injection dosing pump (7), the function of which is synchronized with that of said lifting pump (4).

6. A method according to claim 5, characterized in that said lifting pump functions intermittently, being started up as soon as the waste water in said cesspool exceeds a given limiting level, such that for a lifting pump that can supply said conduit in an amount of (p) m³/h in the lifting period, the dosing pump injects from (0.043×p) mole/h to (0.084×p) mole/h of sodium nitrite.

7. A method according to claim 3 characterized in that over a conduit treatment period of at least 48 h, the possibility of injecting said nitrite into the effluents entering the conduit is interrupted for periods, the cumulative duration of which is equal to at least half said treatment period of at least 48 h.

8. A method according to claim 7, characterized in that injection of said nitrite into the effluents entering the conduit is authorized every other day.

9. A method according to claim 7, characterized in that said nitrite is injected daily into the effluent entering the conduit, but for only a part of the day corresponding to the longest residence time for the effluents in the conduit, any possibility of treatment being interrupted for the other part of the day.

10. A method according to claim 1, characterized in that said combination of bacteria comprises aerobic bacteria that may be pathogenic bacteria selected from the genera Shigella, Shigella, Salmonella, Escherichia, and said hydrolytic anaerobic bacteria of the genus Clostridium and at least one said SRB bacterium selected from the genera Desulfovibrio and Desulfomonas.

11. A treatment facility for use with a method according to claim 6, comprising:
a cesspool (3);
a lifting force main (2), the upstream inlet of which opens into said cesspool (3) and the downstream outlet of which opens at a greater height than that of said cesspool (3); and
a lifting pump (4) that can supply said force main from said cesspool (3);
the facility being characterized in that it further comprises:
a storage tank (12) for said nitrite; and
a dosing pump (7) for injecting said nitrite into the inlet to said force main from said tank (12);
the operation of said dosing pump (7) being capable of being synchronized with the operation of said lifting pump and being capable of operating continuously.

12. A facility according to claim 11, characterized in that it comprises a holding tank (8) including a manhole (10) and cooperating with a gravity fed flow transfer conduit (9) leading to a plant for treating waste water or to a second downstream lifting pump, the outlet from said force main opening into said holding tank, into which said effluents (1) are discharged.

13. A method according to claim 1, wherein said combination of bacteria comprises hydrolytic anaerobic bacteria that can degrade organic matter.

14. A method according to claim 1, wherein the concentration of nitrite injected into the effluent entering said conduit under full load is 0.058 mole/m³ to 0.087 mole/m³.

15. A method according to claim 3, wherein the sodium nitrite is injected at the concentration of 4 g/m³ to 6 g/m³.

16. A method according to claim 3, wherein said sodium nitrite is injected until the concentration of the dissolved sulfide H₂S at the conduit outlet has a concentration of 1 g/m³ or less.

17. A method according to claim 7, wherein the said treatment period is no more than 72 h.
